(19) United States
(12) Patent Application Publication
(10) Pub. No.: US 2004/0207117 A1
(43) Pub. Date: Oct. 21, 2004

(54) Concrete casting process for the manufacture of concrete articles

(76) Inventor: Mario Borsato, Telgate (IT)

Correspondence Address: Richard J Streit, Ladas & Parry, Suite 1200, 224 South Michigan Avenue, Chicago, IL, 60604, US

(21) Appl. No.: 10/484,309

(22) PCT Filed: Jul. 20, 2001
(86) PCT No.: PCT/IT01/00392

(51) Int. Cl. B28B 11/00

(52) U.S. Cl. 264/333; 249/117

(57) ABSTRACT

The present invention relates to a casting process designed specifically for the production of concrete articles and to apparatus for its implementation. More particularly, the present invention relates to a casting process for the production of concrete articles, characterized in that the concrete in cast into moulds made of a material which can be aggregated by compression and subsequently broken up.

The present invention relates to a casting process designed specifically for the production of concrete articles and to apparatus for implementing the method.

In the following description, the term “concrete” is intended to define both the starting mixture and the final article, including the so-called cement, as well as any mixture of cement with suitable additives, aggregants or other materials which may be necessary, according to the applications.

According to the prior art, concrete articles are normally produced by a process which provides for the use of forms which are made of wood, plastics material or, preferably, of metal, and which reproduce the shape of the article to be produced. According to this known process, the concrete is cast, whilst still liquid, into the form, in which it is kept until it sets to form the finished article. The form is then opened so as to release the article and is then subjected to a cleaning step to remove any concrete residue. It should also be noted that the inner surface of the form usually has to be treated with suitable chemical additives which lessen the adhesiveness of the concrete to the metal surface and hence facilitate the cleaning step without, however, eliminating it. However, these chemical additives are generally hazardous or even toxic.

It is clear from the foregoing that the known process has many disadvantages which greatly limit its productivity, that is:

the use of forms which have to be assembled and disassembled before and after each casting, respectively, and which require frequent cleaning operations and chemical treatments is a great burden on maintenance costs and the productivity of the plant;

casting in forms does not permit the implementation of a continuous process, since each form has to be filled individually;

it is not possible to produce hollow, non-linear articles such as curved tubes, T-shaped connectors, etc.

The problem underlying the present invention is therefore that of providing a process which overcomes the above-mentioned disadvantages.

This problem is solved by a concrete-casting process and by the respective apparatus as defined in the appended claims.

Further characteristics and advantages of the concrete-casting method of the present invention will become clearer from the description of some embodiments thereof, given below by way of non-limiting example, with reference to the following drawings:

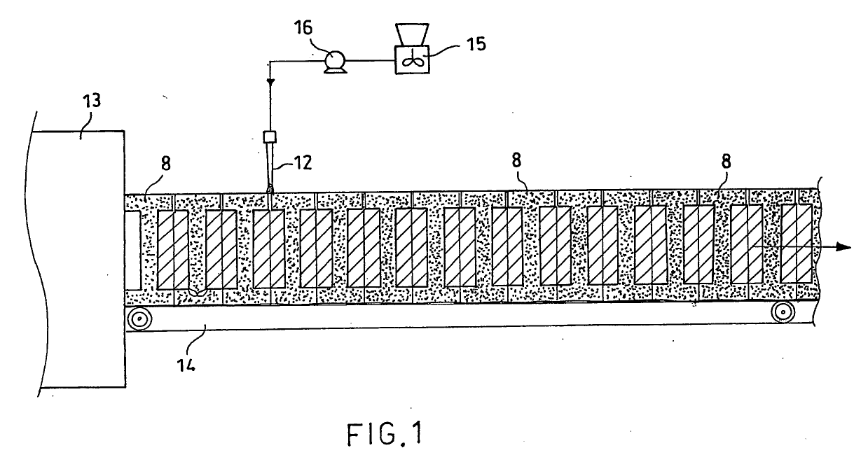

FIG. 1 is a schematic side view of a detail of concrete-casting apparatus according to the present invention,

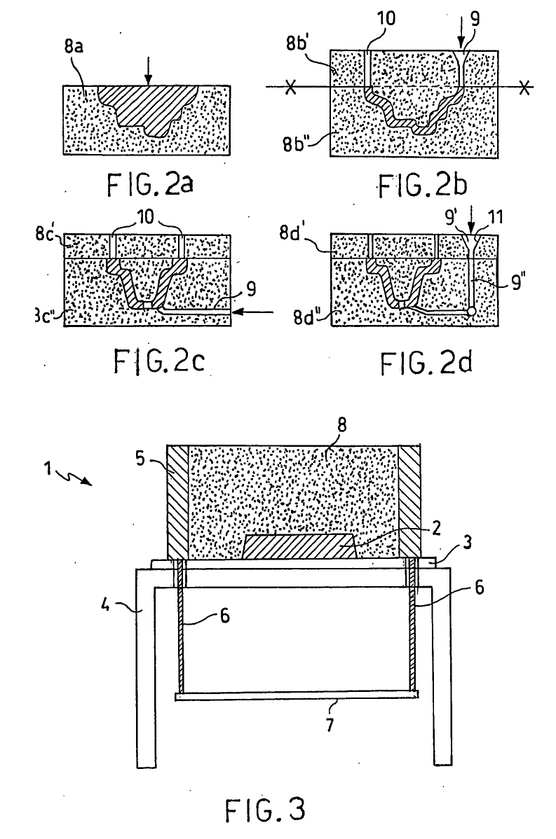

FIGS. 2A, 2B, 2C and 2D show four different types of casting of concrete in moulds according to the present invention,

FIG. 3 is a side view showing, in section, manual apparatus for the production of the mould,

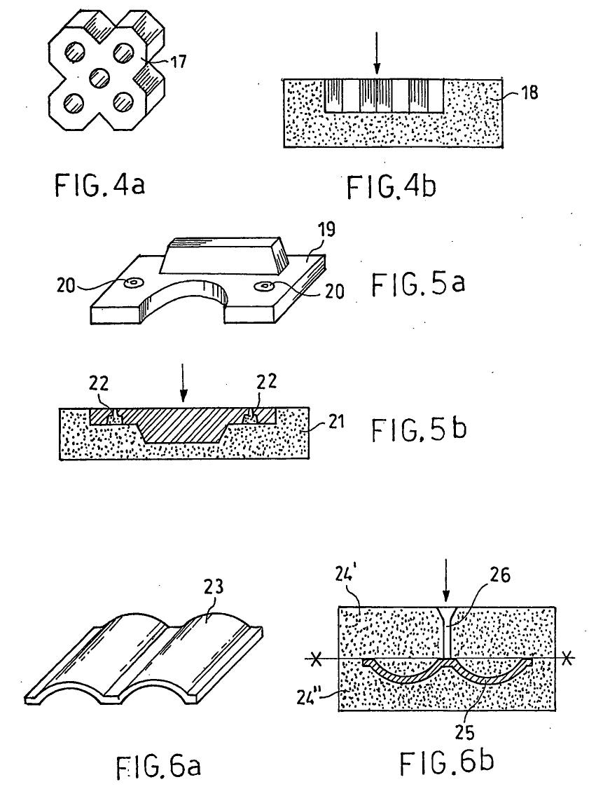

FIG. 4A is a perspective view of a “green”-paving block which can be produced by the process of the invention,

FIG. 4B is a side view showing, in section, a mould for the production of the block of FIG. 4A,

FIG. 5A is a perspective view of a washing-drum counterweight which can be produced by the process of the invention,

FIG. 5B is a side view showing, in section, a mould for the production of the article of FIG. 5A,

FIG. 6A is a perspective view of a tile which can be produced by the method of the invention,

FIG. 6B is a side view showing, in section, a mould for the production of the tile of FIG. 6A,

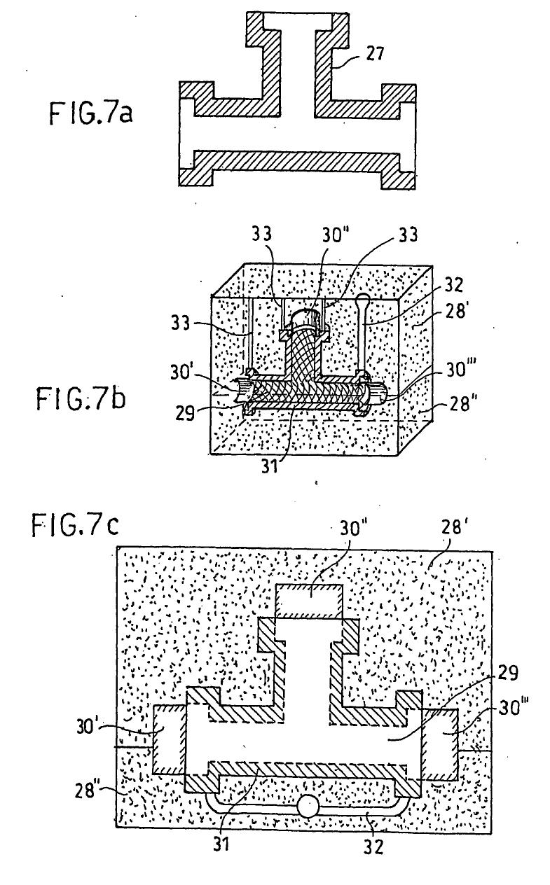

FIG. 7A is a side view showing, in section, a T-shaped pipe connector which can be produced by the process of the present invention,

FIG. 7B is a partially-sectioned, perspective view of a gravity-casting mould for the production of the article of FIG. 7A,

FIG. 7C is a view showing, in section, a bottom-casting mould for the production of the article of FIG. 7A, and

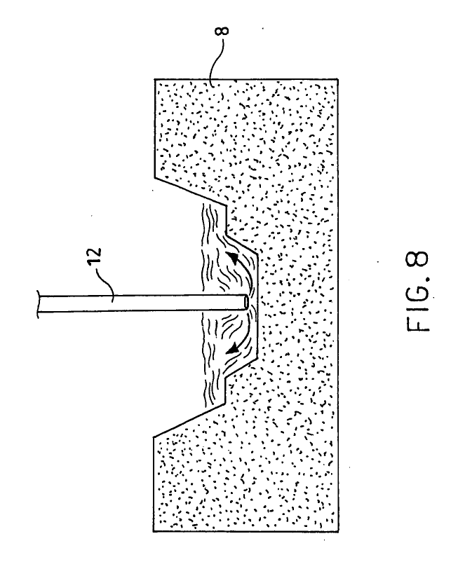

FIG. 8 is a side view showing, in section, an open-top casting mould according to a particular embodiment of the present invention.

The concrete-casting process according to the present invention is characterized in that the concrete is cast into moulds made of material which can be aggregated by compression and subsequently broken up. Once aggregated, the material can preferably be broken up mechanically. More preferably, the material is selected from the group comprising foundry loam, other suitable loam mixtures, and sand, possibly mixed with suitable aggregants.

The process generally comprises the following operative steps:

a) forming of one mould or of a plurality of moulds, in sequence, from a material which can be aggregated by compression, preferably from foundry loam or other suitable loam mixtures or from sand, the moulds reproducing, in negative form, the article to be produced,

b) discontinuous or continuous casting of concrete into the moulds,

c) setting of the article in the mould or in each mould, in sequence,

d) release of the article from the mould or from each mould, in sequence and, optionally,

e) finishing of the article.

In the mould-forming step a), a manual process or, preferably, an automatic process, may be used.

FIG. 3 shows, by way of example, manual mould-forming apparatus, generally indicated 1. A wooden or metal model 2 reproducing, in positive form, the article to be produced, is fixed to a plate 3, which is also made of wood, plastics material or metal and which, in turn, is fixed to a table 4. A moulding box 5, which consists of a parallelepiped, open at the bottom and at the top, rests on the plate 3; the moulding box 5 encloses the model 2 and is fixed to a plate 7 by means of four rods 6 which extend through respective aligned through-holes formed in the table 4 and in the plate 3. The moulding box 5 is then crammed with material, normally foundry loam, which can be aggregated by compression so as to be compacted to an extent such as to produce a mould 8 in which the imprint of the model is maintained in a stable manner. The next step provides for the removal of the mould 8 which, in the embodiment of FIG. 3, is performed by lifting the moulding box 5 by means of the plate 7, to which it is connected. The apparatus described is apparatus with a movable moulding box. It is, however, possible to produce apparatus in which the moulding box 5 remains stationary and the plate carrying the model moves, thus enabling the mould 8 to be removed.

The type of material which can be aggregated by compression which is used may be, for example, so-called foundry loam containing suitable quantities of clay material with agglomerating characteristics and such that, after the addition of small quantities of water (approximately 5%), the loam reaches an adequate degree of cohesion.

The step of ramming in the material which can be aggregated to form the mould is performed in various ways. According to a first possible method, the pressing is performed by mechanical, hydraulic or pneumatic presses. A second method is that of concussion ramming; the moulding box, full of material which has not yet been aggregated, is dropped repeatedly from a predetermined height onto a suitable stop so that the forces of inertia which are developed bring about compaction of the material. A third method provides for the introduction of the material which can be aggregated into the moulding box under pressure. The material is introduced in a jet by suitable nozzles by the effect of compressed air or by means of a mechanical rotor.

Various types of casting (step b) of the process) may be used, according to the article to be produced. The easiest type of casting is the so-called open-top casting which, as shown in FIG. 2A, provides for the concrete to be cast directly into the mould 8A. The second type, shown by way of example in FIG. 2B, on the other hand, provides for the formation of a two-part mould, with an upper half 8B′ and a lower half 8B″. In the embodiment shown, the lower half-mould 8B” comprises the impression of an open-sectioned article (a solid article as in the example of FIG. 2A may be produced in similar manner) and the upper half-mould 8B′ comprises the sprue basin 9 for gravity casting and the air-outlet or air-outlets 10.

FIG. 2C, on the other hand, shows an example of a mould for bottom casting—that is, casting upwards from below—consisting of an upper half-mould 8C″ and a lower half-mould 8C″. In this case, the lower half-mould 8C″ comprises the impression of the article and the sprue basin 9 and the upper half-mould comprises the air-outlets 10.

Similarly, the example of FIG. 2D consists of an upper half-mould 8D′ and of a lower half-mould 8D″. In this case also, the casting is from the bottom but the jet is introduced from above so that the sprue basin is composed of a first section 9′ formed in the upper half-mould 8D′ and by a second section 9″ formed in the lower half-mould 8D″. The first section 9′ of the sprue basin comprises an upwardly-flared mouth 11 through which the jet of concrete is cast. The second section 9″ of the sprue basin, on the other hand, is substantially L-shaped and opens in the vicinity of the base of the impression.

According to a particularly preferred embodiment (shown in FIG. 8) for the production of solid articles by open-top casting, the casting nozzle 12 is introduced into the cavity of the mould 8 as far as a short distance from the base so as to minimize turbulence in the fluid mass of concrete injected by the nozzle, and hence the possible formation of air bubbles which would create imperfections in the article. The advantages of bottom injection can thus be achieved, but with greater structural simplicity. According to this type of casting, the nozzle 12 is submerged gradually in the mass of concrete which, however, owing to its fluidity and to its relatively long setting time, will allow the nozzle to be withdrawn before the article sets. The fluidity of the mass of concrete also permits immediate filling-in of the space occupied by the nozzle in the mass and levelling of the surface. This operation may be facilitated in some cases by a slight vibration to which the mould 8 may be subjected.

The concrete which may be used in the method of the present invention is preferably a fluid concrete such as, for example, a special quick-setting concrete for castings or similar products. A particularly preferred concrete is ITALCEMENTI's concrete known as SCATTO®.

As stated, the casting may also be performed continuously, as shown in FIG. 1. This drawing shows schematically, by way of example, the casting step in a plant for the continuous casting of concrete in accordance with the present invention. In this case, the moulds 8 arrive in sequence from a suitable apparatus 13 which provides for the formation of the moulds from foundry loam or a suitable loam mixture, or the like. Each half-mould comprises, on its two opposed faces, a half-impression of the article to be produced and of the sprue duct. The half-moulds are then coupled in sequence by the apparatus 13 and proceed on a conventional conveyor belt 14 disposed beneath a concrete-injection nozzle 12 which injects the fluid concrete mixture into the moulds. The nozzle 12 is in fluid communication with mixing means 15 which prepare the fluid concrete mass from the solid ingredients. Gravity-casting means or means 16 for pumping the concrete mixture towards the nozzle may be disposed between the mixing means and the nozzle 12. These pumping means 16 are particularly important if pressure-injection into the mould 8 is required.

Step c) of the process of the invention, which provides for the setting of the article inside the mould, is carried out within a period of time generally variable between 30 and 90 minutes. For the apparatus shown in FIG. 1, this step may advantageously be carried out during the transfer of the loam moulds 8 on the conveyor belt 14. In this case, the setting time will depend on the length of the conveyor belt 14 and on its speed of movement. However, the carrying-out of the setting step c) in a region downstream of the plant, optionally in a stationary stage, is not excluded.

Step d) in which the article is released from the loam mould, is achieved by destroying the mould 8. In fact, the degree of cohesion of the material which can be aggregated by compression, of which the mould is composed, is such that sufficiently energetic vibrations cause the material to break up, thus releasing the concrete article. This operation may be performed by vibration, by pressure, or by jolting. In the first case, the mould containing the concrete article, placed on a suitable table connected to vibration means, for example, compressed-air vibration means, is subjected to vigorous vibrations (or forceful compressed-air jets) which detach the aggregated material from the article. This material is then recycled to the mould-forming apparatus. The pressure method of releasing the article, on the other hand, provides for stacking of the moulds and for axial compression of the stack of moulds by means of a suitable press. Finally, according to the jolting release method, the mould is placed on a suitable platform which is then dropped against a stop. The shock is transmitted to the mould, causing the aggregated material to break up and the material is recycled to the forming step as in the previous cases.

Step e) for the finishing of the article is optional and provides for one or more of the following operations: flogging, trimming, and sandblasting.

Flogging is the removal of any traces of aggregated material remaining adhering to the concrete article and is performed by suitable brushes or by compressed-air or water jets.

Trimming is the removal of the portions which are added owing to process requirements (sprue gates, uprights, etc.) and may be performed manually, by suitable tools, or by robots.

In the sandblasting step, the surface of the article is finished by being attacked by pressurized air and sand jets, or by washing with pressurized water jets.

In order to perform the casting in accordance with the embodiment shown in FIG. 8, the apparatus of FIG. 1, described above, will have to be provided with means for vertical movement of the nozzle 12 to enable it to be introduced into the cavity of the mould and subsequently to be removed upon completion of the casting. The apparatus may also comprise vibration means associated with the conveyor belt 14 or with a work station which is disposed immediately downstream of the conveyor belt and in which the moulds must arrive within a period of time sufficiently short for the article not to set.

FIGS. 4A, 5A, 6A and 7A show some examples of articles which can be produced by the method of the present invention. This list is not intended to be in any way limiting and may comprise substantially any type of article which is normally made of concrete such as, for example, road kerbstones, railway sleepers, manhole covers (rings and covers), bricks of all types and shapes, solid, with voids, or with open cross-sections, pipes of all shapes and sizes, plinths, artistic articles of all shapes and types, such as statues, garden furnishings, vases and even artificial cobblestones, etc.

FIG. 4A shows a typical block 17 for “green” paving which is normally used for paving parking areas. The use of these blocks made of concrete (an inert material) instead of known pavings made of plastics material permits a longer life of the paving and prevents problems of contamination connected with the degradation of plastics materials in contact with the ground and with exposure to light and to atmospheric agents. FIG. 4B shows, in section, a mould 18 for the open-top casting of the block of FIG. 4A.

FIG. 5A shows a counterweight 19 of the type which can be used in washing machines. The counterweight 19 comprises through-holes 20 for its fixing to the base of the electrical appliance. Figure 5B shows, in section, a mould 21 for the open-top casting of the article of FIG. 5A. The cores 22 which enable the holes 20 to be produced in the article are visible.

FIG. 6A shows a concrete tile 23. This article can be produced with the mould shown in FIG. 6B, which comprises an upper half-mould 24′ and a lower half-mould 24″. The lower half-mould 24″, which is arranged for the production of an article with an open cross-section, comprises the impression 25 of the tile. The upper half-mould 24′, on the other hand, comprises the sprue basin 26 for gravity casting. The sprue basin 26 terminates at the top in a funnel-shaped opening for facilitating the injection of the fluid concrete mixture.

FIG. 7A shows a T-shaped pipe connector 27. This article cannot be produced by known form-casting techniques since the core which reproduces the void inside the piping cannot be removed once the casting has set.

According to the process of the present invention, the T-shaped connector 27 can advantageously be produced by the formation of a core of material which can be aggregated by compression and subsequently broken up. In step d) for the release of the article, the core will also break up, giving rise to the desired T-shaped connector.

FIG. 7B shows a mould for the production of the article of FIG. 7A. This mould comprises an upper half-mould 28′ and a lower half-mould 28″, the two coupled half-moulds defining an impression corresponding, in negative form, to the outer body of the article to be produced. The cavity which this impression defines houses, in an appropriate position, the core 29 which reproduces, in negative form, the void in the article to be produced. The core 29 comprises, at each end, core supports 30′, 30″, 30′″ which are housed in corresponding seats formed in the two half-moulds and the function of which is to keep the core suspended in the appropriate position for producing the void in the article. The core is normally placed on the half-seats of the lower half-mould 28″, which is then coupled with the upper half-mould 28′.

Naturally, between the core and the internal walls of the cavity of the impression, there is a space 31 which reproduces, in negative form, the solid body of the article to be produced.

The core 29 is normally made of compressed sand, preferably moulding sand, and binders, and is produced by the coupling of two half-core boxes produced by respective half-moulds, by a forming method similar to that described above for the production of the loam moulds.

Alternatively, the core may be made of a material which can easily be removed after casting such as, for example, polystyrene.

The example of FIG. 7B shows a gravity casting. The upper half-mould therefore comprises a sprue basin 32 and air-withdrawal ducts 33 wholly similar to those shown in FIG. 2B and described above.

FIG. 7C shows a mould for the production of the same article of FIG. 7A with the sole difference that the type of casting is bottom casting. The same numerals indicate the same parts as for the mould and the core shown in FIG. 7B.

It should be noted that the method according to the present invention permits the production of any type of hollow concrete article having at least one opening communicating between the interior of the article and the exterior, and having a non-linear shape, that is, an article from which a core which could not be broken up would be impossible to remove by being slid out.

Concrete articles with fixed metal cores (reinforced concrete) can also be produced by the above-described process by suspending the metal reinforcement in the mould as described, and by casting the concrete. Any composite articles which require the insertion of a fixed core made of various materials, either metal or plastics materials, for example, thermal or acoustic insulation or materials for reducing weight, can be produced in similar manner.

As is clear from the foregoing description, the process of the invention has many advantages over the techniques of the prior art.

In the first place, the replacement of the forms with moulds of compressed loam or sand with binders drastically reduces maintenance costs and the times required for the operation as a whole.

Since this process can be performed with a continuous cycle with the use of known automatic apparatus for the formation of loam moulds in sequence and subsequent casting in the moulds which are movable on a conveyor belt, it achieves maximum productivity of the plant. By way of example, for the production of road kerbstones, it would be possible to consider producing moulds each containing impressions for 6 castings and an automatic machine which can process 300/500 moulds per hour would thus enable 1800/3000 castings to be produced per hour. This corresponds to a productivity 3 to 5 times greater than that of the conventional technology.

A further advantage is connected with the fact that concrete tends to stick less to loam than to the metal of which the forms are normally made. This has the consequence, on the one hand, that treatment with chemical release additives, which is required for forms, can be avoided and, on the other hand, it is possible to produce articles with better finishing than conventional articles, particularly in the regions of corners, edges, or precise artistic workmanship.

Naturally, only some specific embodiments of the concrete-casting process of the present invention have been described and a person skilled in the art will be able to apply any modifications necessary to adapt it to particular applications without, however, departing from the scope of protection of the present invention.

For example, more than one concrete-injection nozzle may be provided in the plant shown in FIG. 1. Moreover, the nozzle or nozzles may equally well be arranged for gravity casting (as shown in the drawing) or for bottom casting.

1. A casting process for producing concrete articles, wherein the concrete is cast into moulds made of a material which can be aggregated by compression and subsequently broken up.

2. A process according to claim 1 in which the moulds made of material which can be aggregated are broken up mechanically.

3. A process according to claim 1 in which the material which can be aggregated by compression is selected from the group comprising foundry loam, other suitable loam mixtures, and sand, possibly mixed with suitable aggregants.

4. A casting process for producing concrete articles, wherein the concrete is cast into moulds made of a material which can be aggregated by compression and subsequently broken up, the process comprising the following operative steps:
a) forming of one mould or of a plurality of moulds, in sequence, from the material which can be aggregated by compression, the moulds reproducing, in negative form, the article to be produced,
b) discontinuous or continuous casting of concrete into the moulds,
c) setting of the article in the mould or each mould, in sequence,
d) release of the article from the mould or from each mould, in sequence and, optionally,
e) finishing of the article.

5. A process according to claim 4 in which the step of the forming of the moulds comprises the following operative steps:
i) preparation of a model reproducing, in positive form, the article to be produced,
ii) fixing of the model to a plate, inside a moulding box,
iii) ramming of the material which can be aggregated by compression into the moulding box, applying sufficient pressure to aggregate the material so as to form the mould,
iv) removal of the mould from the moulding box.

6. A process according to claim 1, in which the mould comprises an upper half-mould and a lower half-mould, the lower half-mould comprising the impression of an article and the upper half-mould comprising the sprue basin composed of one or more sprue ducts for gravity casting, and one or more air-outlets.

7. A process according to claim 4, in which the mould comprises an upper half-mould and a lower half-mould, the lower half-mould comprising the impression of an article and the upper half-mould comprising the sprue basin composed of one or more sprue ducts for gravity casting, and one or more air-outlets.

8. A process according to claim 1, in which the mould comprises an upper half-mould and a lower half-mould, the lower half-mould comprising the impression of an article and the sprue basin composed of one or more sprue ducts for bottom casting, and the upper half-mould comprising one or more air-outlets.

9. A process according to claim 4, in which the mould comprises an upper half-mould and a lower half-mould, the lower half-mould comprising the impression of an article and the sprue basin composed of one or more sprue ducts for bottom casting, and the upper half-mould comprising one or more air-outlets.

10. A process according to claim 1, in which the mould comprises the impression of an article for open-top casting.

11. A process according to claim 1, in which the concrete is a fluid concrete, preferably of the special quick-setting type for castings or similar articles.

12. A process according to claim 1 in which the concrete is ITALCEMENTI's SCATTO® concrete.

13. A process according to claim 4, in which the step of the setting of the article in the mould is continued for a period of time variable from 30 to 90 minutes.

14. A process according to claim 4, in which the step of the release of the article from the mould is performed by a vibration, pressure, jolting, or shooting technique.

15. A process according to claim 4, in which the step of the finishing of the article provides for one or more of the following processes: flogging, trimming and sandblasting.

16. A process according to claim 4 in which the step of the finishing of the article provides for a flogging step, said flogging step being performed with brushes or by means of compressed-air or water jets.

17. A process according to claim 4, in which the step of the finishing of the article provides for a trimming step, said trimming step being performed manually or by means of suitable tools or robots.

18. A process according to claim 4, in which the step of finishing of the article provides for a sandblasting step, said sandblasting step being carried out by attacking the surface of the article with pressurized sand, air or water jets.

19. A process according to claim 1, in which the article is a hollow concrete article having at least one opening communicating between the interior of the article and the exterior and having a non-linear shape, and in which the mould comprises an upper half-mould and a lower half-mould, the half-moulds, after mutual coupling, defining an impression corresponding, in negative form, to the outer body of the article to be produced, the cavity which defines the impression housing, in an appropriate position, a core reproducing, in negative form, the void in the article to be produced, the core comprising, at each end, core supports to be housed in corresponding seats formed in the half-moulds so as to keep the core suspended in the position appropriate for the production of the void in the article, there being defined between the core and the internal walls of the cavity of the impression a concrete-casting space reproducing, in negative form, the solid body of the article to be produced.

20. A process according to claim 4, in which the article is a hollow concrete article having at least one opening communicating between the interior of the article and the exterior and having a non-linear shape, and in which the mould comprises an upper half-mould and a lower half-mould, the half-moulds, after mutual coupling, defining an impression corresponding, in negative form, to the outer body of the article to be produced, the cavity which defines the impression housing, in an appropriate position, a core reproducing, in negative form, the void in the article to be produced, the core comprising, at each end, core supports to be housed in corresponding seats formed in the half-moulds so as to keep the core suspended in the position appropriate for the production of the void in the article, there being defined between the core and the internal walls of the cavity of the impression a concrete-casting space reproducing, in negative form, the solid body of the article to be produced.

21. A process according to claim 4 in which the article is a hollow concrete article having at least one opening communicating between the interior of the article and the exterior and having a non-linear shape, and in which the mould comprises an upper half-mould and a lower half-mould, the half-moulds, after mutual coupling, defining an impression corresponding, in negative form, to the outer body of the article to be produced, the cavity which defines the impression housing, in an appropriate position, a core reproducing, in negative form, the void in the article to be produced, the core comprising, at each end, core supports to be housed in corresponding seats formed in the half-moulds so as to keep the core suspended in the position appropriate for the production of the void in the article, there being defined between the core and the internal walls of the cavity of the impression a concrete-casting space reproducing, in negative form, the solid body of the article to be produced, wherein the core is made of compressed sand, preferably moulding sand, and is produced by the coupling of two half-core boxes produced by respective half moulds.

22. A concrete article which can be produced in accordance with the process defined in claim 1.

23. A concrete article which can be produced in accordance with the process of claim 4.

24. A concrete article which can be produced according to the article of claim 21.

25. A concrete article which can be produced in accordance with the process of claim 4, the article being selected from the group comprising road kerbstones, railway sleepers, manhole covers (rings and covers), bricks of all types and shapes, solid, with voids, or with open cross-sections, pipes of all shapes and sizes, plinths, artistic articles of all shapes and types, such as statues, garden furnishings, vases and artificial cobblestones, blocks for “green” paving, counterweights or ballast, and tiles.

26. A concrete article which can be produced according to the process of claim 21, in which the article is a hollow concrete article having at least one opening communicating between the interior of the article and the exterior and having a non-linear shape.

27. A plant for implementing the method defined in claim 1, the plant comprising apparatus for forming the moulds made of material which can be aggregated by compression, a conveyor belt which takes the mould or moulds from the mould-forming apparatus in sequence and carries them to a concrete-casting region in which one or more concrete-casting nozzles are disposed, the nozzles providing for the introduction of the fluid concrete mixture into the moulds, the one or more nozzles being in fluid communication with mixing means which provide for the preparation of the fluid mass of concrete from solid ingredients, means for the gravity-casting or for the pumping of the concrete mixture towards the nozzle or nozzles optionally being disposed between the mixing means and the one or more nozzles.

28. A plant according to claim 27 in which the one or more nozzles are arranged for bottom injection.

29. A plant according to claim 27 in which the one or more nozzles are arranged for gravity or open-top injection.

30. A plant according to claim 27 in which means are provided for the vertical movement of the one or more nozzles for enabling the nozzles to be introduced into the cavity of the mould and subsequently removed upon completion of the casting.

31. A plant according to claim 27 in which vibration means are also provided, and are associated with the conveyor belt or with a work station which is disposed immediately downstream of the conveyor belt and which the moulds must reach within a period of time sufficiently short for the article not to set.
